(19) United States
(12) Patent Application Publication
(10) Pub. No.: US 2011/0310215 A1
(43) Pub. Date: Dec. 22, 2011

(54) Customizable internet based system for real-time multi-media tele-presence of large dynamically varible number of users

(76) Inventors: Mauro Pacelli, San Diego, CA (US); Luca Pacelli, San Diego, CA (US)

(21) Appl. No.: 13/134,463

(22) Filed: Jun. 8, 2011

Related U.S. Application Data
(60) Provisional application No. 61/356,622, filed on Jun. 20, 2010.

(51) Int. Cl. H04N 7/15; G09G 5/00; H04N 9/76

(52) U.S. Cl. 348/14.07; 348/598; 345/660; 348/E07.083; 348/E05.051

(57) ABSTRACT

A System for video and audio real-time communication among a large Community of members connected to Internet via local computers, cell phone or iPads with a webcam and a Central Computer System. The User's Devices and the Central Computer System are made of commercially available hardware and they run standard software plus proprietary software described in this patent. The Proprietary Software, VRTCOS, runs in the Central Computer System. All the users have a Community ID and a Profile. Upon request, every user is presented with the video and audio signals from a subset of the Community's members, the User's Neighborhood, in only one video stream. Neighborhood of 30 users can be achieved with a Central Computer System of average power.

The technology allow to develop a large set of application for video-based Social Networking.

### REFERENCED CITED

U.S. Pat. No. 5,657,096

### BACKGROUND OF THE INVENTION

Existing Video-based Communication Systems allow a limited number of users or require special expensive customized hardware systems (U.S. Pat. No. 5,657,096) The result is a limited usage of multi-users audio-and-video communication systems and the explosion of text or voice-only multi-users communication systems such as the existing social networking systems.

With this invention social interaction can become as real as the typical interaction of real people when they meet in a pre-organized gathering (party, congress, business meetings, etc.) or when they accidentally meet in a public place (shopping center, theater, etc.).

This invention allows each user to achieve these results using their existing Computer equipment or mobile phones by delivering the audio-and-video streams from the other users in only one audio-and-video stream

### SUMMARY OF THE INVENTION

The invention allows to build a system, based on software named VRTCOS (6.1.23) and commercially available hardware, for a Community of users equipped with devices able to capture local videos, who want to transmit via Internet their webcams videos and/or other videos residing in Internet Databases to other Community's users. Users can dynamically join or abandon the community

The invention allows a Central Computing System (6.1.9), running VRTCOS (6.1.23), to receive videos from the users' webcams and deliver to each user upon user's request a set of videos of other users in only one video stream. The set of videos can also contain videos from Internet Databases (6.1.5).

VRTCOS (6.1.23) requests and controls the members' profiles in the Community, download special software in each member device, control the login of each member of the Community and assign to each user a Community Location (6.1.15) when the user login

VRTCOS (6.1.23) allows each user to define a subset of Users' Videos (User's Neighborhood (6.1.12)) to be shown in his/her screen (Composite Video (6.1.13)) according to users' profiles and verifies the acceptability of the subset depending by the characteristics of the user's device and the Central System Characteristics. Default Neighborhoods are subsets of users whose Community Location is “close” to the User's Location (6.1.15).

User can dynamically change the User's Neighborhood (6.1.12).

VRTCOS (6.1.13) tries to preserve the original simultaneity of the users' videos when it displays the User's Neighborhood. VRTCOS (6.1.13) achieve this by sending to the peripheral devices, at Central Time Intervals (6.1.18) requests to start capturing the local videos and by buffering groups of frames (6.1.12.2).

Each user can chose among several geometric representation (6.1.14) of the Display of the Composite Video

Each user defines the type of permission (6.1.8) to be granted to other users in relation to the user's video, such as permission to be seen only, to be seen arid heard

Using a Central Computing System comparable in power to AMD Opteron 6000, the estimated maximum number of users (6.1.12.1) in a User's Neighborhood is 336. A very large number of users can be managed by a system with several parallel processors, such as the Cray XT5

Several options are allowed in the System

Option to choose among several video formats to be used as a common format depending by the particular application run by the System

Option to choose the Central Time Interval (6.1.8)

Options to choose among several geometric representation (6.1.14) of the Composite display

Options for the user to choose among several criteria for defining the User's Neighborhood (6.1.12)

### BRIEF DESCRIPTION OF THE DRAWINGS

FIG. 1 is the pictorial representation of the Total System Architecture

FIG. 2 is a pictorial representation of the critical processes, Frames' Collaging (6.1.21) and Mixing sounds (6.1.22) performed by VRTCOS (6.1.23) in the Central Computer System

FIG. 3 is a detailed pictorial representation of the Collaging Technique (6.1.21)

FIG. 4 is a pictorial representation of various types of User's Neighborhood (6.1.12)

FIG. 5 is a pictorial representation of an example of the users' webcam videos and of their Composite Video (6.1.13)

FIG. 6 is a pictorial representation of the VRTCOS (6.1.23) internal architecture

FIG. 7 is a pictorial representation of the Composite frame with the coordinates of the User's frame and a generic Neighbor frame

### DETAILED DESCRIPTION OF THE DRAWINGS

In the previous descriptions of the invention we have used specific terms, which we are defining now in details together with other terms for a better understanding of the Drawings' description.

In the following description references to elements of a Figure will be identified in bold characters by the Figure number and by the number of the element.

We recommend that the reader of this Patent start reading the Description of Drawings (6.2) and then read the Definition of Terms when needed.

### DEFINITION OF TERMS

### User's Device

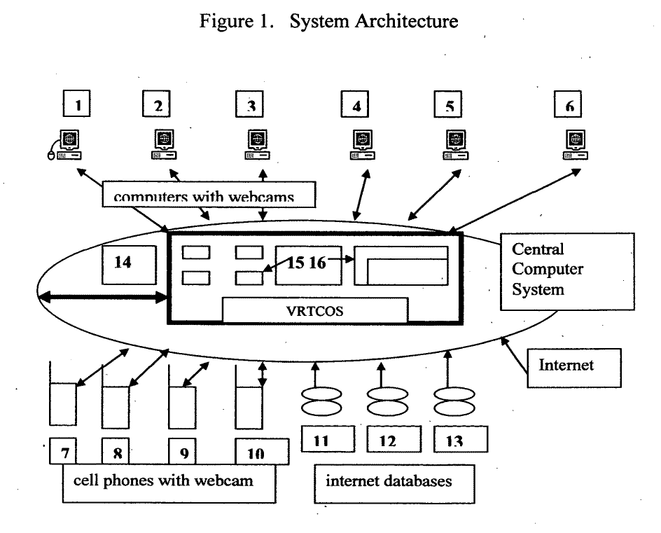

It is a User's Computer or a User's cell phone or iPad connected to Internet, FIGS. 1, 1 to 10

### User's Webcam

It is a webcam connected to a User's device

### User's Video

It is a Video made with a User's Webcam in the User's device

### User's Video Format

It is the Video Format generated by the User's webcam software in the User's device

### Database Video

It is a video residing in a Database connected to Internet, FIGS. 1, 11 to 13

### User's Video Community

It is a set of users who want to communicate via video

### User's Video Membership

It is the act of subscribing to a User's Video Community. Every Community will create its own Acceptance Criteria, i.e. the criteria to be satisfied in order to be accepted in the Community.

### User's Profile

It is the set of information requested to a User when the User subscribes to a User's Video Membership. This includes personal information and the User's privacy requirements. The Standard User's privacy options relative to a set of users are:

a) to be seen only. This user agrees to send his/her muted video and to receive videos from users. This user will be called Sender

b) to be seen and heard. This user agrees to send his/her video and to receive videos from users. This user will be called Sender

c) not to be seen. This user want to receive videos from users but does not want to be seen. This user will be called Receiver

### Central Computer System

It is a Computer system connected to Internet and accessible via Internet by each User's Device, FIG. 1, 14. The Central Computer System runs the proprietary Software “Video Real Time Communication System” or VRTCOS (6.1.23) which allows the Central Computer System to perform the actions described in this patent.

### Common Video Format

It is a video format enforced by the Central Computer System on all the User's Devices through software downloaded to the User's device.

### User's Log In

It is the act of a User when the User requests to access VRTCOS (6.1.23) in the Central Computer System

### User's Neighborhood

It is the set of the Community Users whose Videos will be shown to the User. The Neighborhood can be of two types:

a) The Default Neighborhood. The Central Computer System computes the number N of users in the Neighborhood and the New Size Si of the Neighborhood Video's Frames according to the size of the Neighborhood Composite Frame (6.1.16)

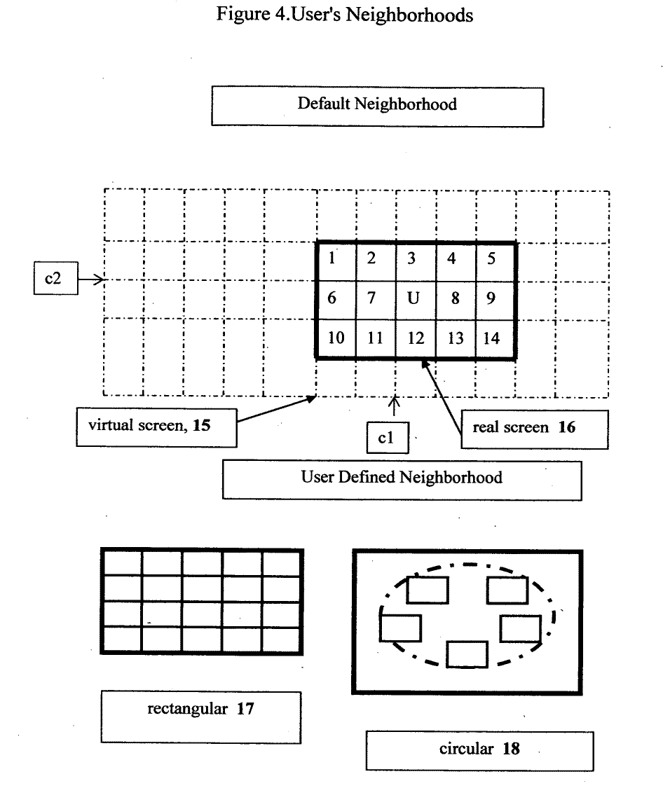

The Central Computer System uses a Virtual Two-dimensional Space, The Virtual Screen (6.1.24), FIG. 4, 15, which is made of Digital Pixels and is large enough to accommodate all the videos, in the New Size S1, of the members (6.1.7) of the VRTCOS (6.1.23) Service.

The Central Computer System assigns to each user at log-in time the User's Virtual Coordinates, c1, c2 (6.1.15) in the Virtual Screen (6.1.24)

The User's Neighborhood is made by the set of N users whose Location is in the proximity of the User's Location (6.1.15), FIGS. 4, 1 to 14. The User's video, FIG. 4, U, is surrounded by the video of the Neighbors who have logged in. This type of Neighborhood is useful when VRTCOS (6.1.23) is used to present an environment similar to a public place, such as a Mall or a Park where people see and meet unexpected persons. A User can “move” in the Virtual Screen by asking for a new available location.

Let's now see how the Neighborhood is assigned by the System to a User Uᵢ.

Let's assume that a user's resized frame (6.1.17) has X pixels in a row and Y rows.

A user Uᵢ with coordinates (6.1.15) c1ᵢ and c2ᵢ has a resized video whose generic pixel coordinates u1ᵢ and u2ᵢ satisfy these conditions

c1ᵢ<u1ᵢ<c1ᵢ+X−1, c2ᵢ<u2ᵢ<c2ᵢ−(Y−1)

Let's assume that the Uᵢ's Neighborhood is made of n videos on a row and m rows.

Let's assume that the number n and m are odd numbers so that the Uⱼ's video can be placed at the center of a rectangle with n video on a row and m rows (FIG. 4).

Under these assumptions the Coordinates N1ᵢⱼ and N2ᵢⱼ of the User Uⱼ of the user Uᵢ's Neighborhood satisfy the following relations

c2₁−((m−1)/2)*Y<=N2ᵢⱼ<=c2ᵢ+((m−1)/2))*Y

c1ᵢ−((n−1)/2*X<=N1ᵢⱼc1ᵢ+((n−1)/2))*X (1)

which are equivalent to

N1ᵢⱼ−((n−1)/2)*X<=c1ᵢ<=N1ᵢⱼ+((n−1)/2*X

N2ᵢⱼ−((m−1)/2)*Y<=c2ᵢ<=N2ᵢⱼ+((m−1)/2))*Y (2)

The partition of the Virtual Screen (6.1.24) in rectangular shapes of X*Y pixels can be done by VRTCOS (6.1.23) before any user sign on the System. If the number of signed user exceeds the number of the rectangular shapes in the Virtual Screen, VRTCOS adds more rectangular shapes.

If the Central Computer is a multiprocessor computer, VRTCOS can allocate groups of users, i.e. their virtual coordinates, to Processors. The number of users per processor (6.1.12.1,N&C Table), depends by the performance of the processor.

Now VRTCOS can build a global table relating User's ID (or User's coordinates) to each processor where the User's frames appear in a Neighborhood of users allocated to that processor. When a frame arrives at the Central Computer, VRTCOS send copy of the frame to each one of these processors. When one of these processors receives the frame, the Frame Processor (6.1.23.1) signals the Application Processor (6.1.23.2) which in turn asks the Frame Processor to transfer the Digital Pixels to the Composite Frame (6.1.16) using the Collaging Technique (6.1.21) and to transfer the Sound Samples using the Mixing Technique (6.1.22). Various methods can be used by VRTCOS for assigning a newly arrived frame to its Neighborhood.

VRTCOS builds a table whose generic entry has the following format and content

| | | | |
|---|---|---|---|
| IDᵢ | c1ᵢ | c2ᵢ | Qᵢ |

where Qᵢ is reference to the processor and location where the Composite Frame for the User with Coordinate c1,c2 resides.

X,Y, n, m are VRTCOS parameters with assigned values before any user sign on.

A soon as a User log in, c1ᵢ, c2₁ and Qᵢ acquire values.

When a new frame arrives with coordinates N1ᵢⱼ and N2ᵢⱼ, VRTCOS finds the entries of the table that verify the conditions (2) and for each of these entries VRTCOS send a copy of the frame to the processor referenced by Qᵢ.

Another method for assigning a newly arrived frame to all the Neighborhoods it belongs to is to use two tables connected by a relationship. The first table's generic entry contains the pair of pixel coordinates of all the resized videos and the other table's generic entry contains the pair of pixel coordinates and the reference to the processor and location where the Neighborhood's Composite will be sent.

The two tables are in a relationship Frame-Neighborhood.

TABLE 1

| | | | |
|---|---|---|---|
| 1 | ID₁ | C1₁ | C2₁ |
| 2 | ID₂ | C1₂ | C2₂ |
| 3 | ID₃ | C1₃ | C2₃ |
| 4 | ID₄ | C1₄ | C2₄ |
| 5 | ID₅ | C1₅ | C2₅ |

TABLE 2

| | |
|---|---|
| 1 | 1 |
| 1 | 4 |
| 1 | 5 |
| 2 | 2 |
| 2 | 3 |
| 3 | 1 |
| 3 | 4 |
| 3 | 5 |

TABLE 3

| | | | |
|---|---|---|---|
| 1 | C1₁ | C2₁ | Q₁ |
| 2 | C1₂ | C2₂ | Q₂ |
| 3 | C1₃ | C2₃ | Q₃ |
| 4 | C1₄ | C2₄ | Q₄ |
| 5 | C1₅ | C2₅ | Q₅ |

The three tables are built by VRTCOS before any user subscribes.

The Qᵢ are defined by VRTCOS when user Uᵢ logins

When a new frame arrives, VRTCOS finds the frame's c1 and c2 from the frame's source ID and then from the corresponding entry in Table 1 and its relations in Table 2 VRTCOS find in Table 3 all the locations where to send copies of the frame.

a1) A User may ask to change Neighborhood in many different ways. The User can ask for the first available location in the Virtual Screen in a given direction. The User can ask for the closest position to another User by providing the other User's ID.

If the request is accepted, VRTCOS needs to associate with the User ID different coordinates (6.1.15) c1 and c2 in the Virtual Screen (6.1.24), assign a different memory location to the User's Composite Frame (6.1.16) identify. the Users in the new Neighborhood.

When VRTCOS (6.1.23) create the Virtual Screen (6.1.24), the coordinates of all the users are also created. At that time VRTCOS will determine the Neighborhood for each user location in the Virtual Screen and will create the User's Composite. Frame.

b) The User Defined Neighborhood. The User defines each user in the User's Neighborhood by providing selection criteria based on the Users' Profiles.

The Central Computer System, using the number N of the Users in the Neighborhood, computes the size S1 (6.1.17) of the of the Neighborhood Video's Frames according to the size of the Neighborhood Composite Frame, (6.1.16)

The User can reject the size S1, chose another Neighborhood and get another value for the size S1.

The coordinate of each user's video inside the Composite Video are assigned by the System.

In this case every set of coordinates c1, c2, is associated with the list of coordinates pairs of the corresponding Neighborhood Users

### The N Values

In both the cases a) and b) the numbers N and S1 must verify some conditions in order to guarantee that the Composite Frame (6.1.16) will be delivered to destination within a CTI (6.1.18). In order to obtain these conditions we need to develop an approximate relationships between the Computer Power, the maximum number of the members of a Neighborhood (6.1.12), the size of the Composite Frame (6.1.16) and the rate of frame arrival from the webcams.

Let's Pₘₐₓ be the Computer power measured in gigabytes/sec transferred

Let's assume that P=70% Pₘₐₓ is the Computer Power in Gigabytes/sec available to VRTCOS

Let's N be the number of the members of a Neighborhood

let's R be the rate of the movie frames in sec (un frame every R seconds)

let's S be the size of the Composite Frame in Gigapixels, i.e. Number of horizontal pixels×number of rows/1000,000,000

Let's B be the number of bytes per pixel

Let's S1 be the size in Gigapixel of each reduced user frame (6.1.17)

Let's T Be the time to resize a user frame

Let's C be the number of Composites that can be done in R seconds

S×B=number of Gigapixel bytes to be transferred to the Composite frame (6.1.16)

P/2=the number of Gigabytes moved to the Composite frame (6.1.16) per sec (usually it takes two transfer, memory to register and register to memory)

P×R/2=number of bytes moved to the Composite frame (6.1.16) in R sec

Assuming that sound mixing requires moving the same number of bytes as for the pixels, then

2×S×B must be <P×R/2

### S<P×R/(4×B)

### N×S1=S<P×R/(4×B)

### N<P×R/(4×B×S1)

### S1<P×R/(4×B×N)

2×S×B/P/2=approximate time to make a Composite frame (6.1.16) from resized frames (6.1.17)

N×T=time to resize N frames

N×T+8×S×B/P=total time to make a Composite frame (6.1.16). It must be less than R

N<(R−8×S×B/P)/T

T is no greater than the time to fill the Composite frame=2×S×B/P

### N×T+8×S×B/P<=2×N×S×B/P+8×S×B/P<R

### N<=(R×P−8×S×B)/(2×S×B)

In the following table we show
a) The maximum values of N for some values of Pₘₐₓ, S, and B
b) Some values of C for N=15 and few values of Pₘₐₓ, S, and B

N&C Table

| | 0.033 | 0.066 | 0.033 | 0.066 | 0.033 | 0.066 |
|---|---|---|---|---|---|---|
| R | (1/30) | (1/15) | (1/30) | (1/15) | (1/30) | (1/15) |
| Pₘₐₓ | 10⁽¹⁾ | 10⁽¹⁾ | 20⁽²⁾ | 20⁽²⁾ | 336⁽³⁾ | 336⁽³⁾ |
| P | 7 | 7 | 14 | 14 | 235 | 235 |
| S⁽⁴⁾ | 0.00034 | 0.00034 | 0.00034 | 0.00034 | 0.00034 | 0.00034 |
| B | 2 | 2 | 2 | 2 | 2 | 2 |
| N<= | 166 | 336 | 336 | 675 | 5698 | 11400 |
| N | 15 | 15 | 15 | 15 | 15 | 15 |
| C | 10 | 20 | 20 | 45 | 379 | 760 |

⁽¹⁾AMD 1000
⁽²⁾AMD 2000
⁽³⁾AMD 6000
⁽⁴⁾the size S is set at 720×480 pixels/10⁹

The AMID Opteron 6000 runs at 42 Gigahertz and the parallelism is 64 bits=8 bytes, therefore Pₘₐₓ, is 42*8=336

One Large Cray XTS System can accommodate up to 240,000 AMD 6000 processors. It can handle up to 2.736 Billion of users.

An Estimate for the memory required to accommodate 5698 users can be calculated in this way. For each user we need to have in memory:

1) a list entry of this type (22 64-bits words)

| | | | | | | | |
|---|---|---|---|---|---|---|---|
| 1 or 0 | C₁ | C₂ | . . . | N_{1,i} | N_{2,i} | . . . | frame addrs |

| | | | |
|---|---|---|---|
| assign | User | Neighborhood | frameaddress |
| or not | coordinates | coordinates | |

2) one copy of the user frame (11,000 64-bits words)

3) one copy of the composite frame (173,000 64-bits words)

4) the of neighborhood addresses (15 64-bits words)

A total of 184,000 words per user. For 5698 users a total of 1.05 Giga words.

### Client Frames Synchronization

Given the large number of Client frames that belong to the same Capture Group (6.1.18.2), there is a high probability that the frames of the same Capture Group arrive at the Central Computer System at different times and that these delay may be also larger than a CTI (6.1.18)

In order to optimize the re-synchronization of frames' arrival, i.e. to create a Composite with the maximum number of frames of the same Capture Group (6.1.18.2) VRTCOS offers as an option to let each Composite Frame (6.1.16) wait two CTI (6.1.18) before being streamed to the destination Computer. Since during the second CTI some frames of the second Capture Group may arrive at the Server, VRTCOS create two Composite Frame, one, let's call it C1, for the current Capture Group, CG1, and a second one, let's call it C2, for the next Capture Group, CG2.

At the end of the second CTI, after streaming C1, C1 will be replaced in the server's memory by C3. At the end of the third CTI, C2 will be replaced by C4, and so on by flip-flopping Composite Frames.

This option reduces to half the frequency of the Composite Video frames. For example , if the Webcam capture frequency is 1/30 of a second, then the frequency of the Composite Video frames is 1/15 of a second , which is till acceptable.

### Allocation of the Client's Frames in the Composite

After verifying that N satisfy the inequality of the “N<=” row, VRTCOS shows to the user the S1.

The Composite Frame (6.1.16), when is delivered to the destination Computer, will show n resized frames per row and m resized frames per column.

Let's now compute n and m.

Let's L be the number of pixel in a Composite Frame row.

Let's H be the number of pixels in a Composite frame column

Then S=L*H

Let's X be the number of pixels in row of a resized Neighborhood frame

Let's Y be the number of pixels in a column of a resized Neighborhood frame

n*X=L

m*Y=H

n*m=N

Therefore

n=integer(L/X)

m=integer(N/n)=integer(N/integer(L/X))

Example: L=720, H=480, X=100,Y=60

| | | | | |
|---|---|---|---|---|
| N | 25 | 40 | 60 | 100 |
| n | 7 | 7 | 7 | 7 |
| m | 3 | 5 | 11 | 14 |

### Neighborhood Composite Video

It is the Video that displays all the Videos of a Neighborhood (6.1.12)

### Neighborhood Composite Video Geometry

It is the geometric configuration of the webcam videos and database videos locations in the Neighborhood Composite Video. In the case of Default Neighborhood (6.1.12, a)) the video location is defined by the Central Computer System.

In the case of User Defined Neighborhood (6.1.12, b) several Options can be selected by the user for the Neighborhood Composite Video Geometry . Two examples are: Rectangular, FIG. 4, 17, Circular, FIG. 4, 18

### Coordinates of a User's Frame in the Virtual Screen

They are the coordinates c1 and c2, in the pixel space of the Virtual Screen (6.1.24) of the first pixel of the first row of the User's Frame in its location in the Virtual Screen (6.1.24).

The coordinates will be assigned in such a way that all the Neighborhood Videos do not overlap when shown in the User's screen. VRTCOS offers also an option to leave the empty the location surrounding a User's Video. This option will allow Users (Videos) to move in the Virtual Screen.

### Coordinates of a User's Frame in the Composite Frame

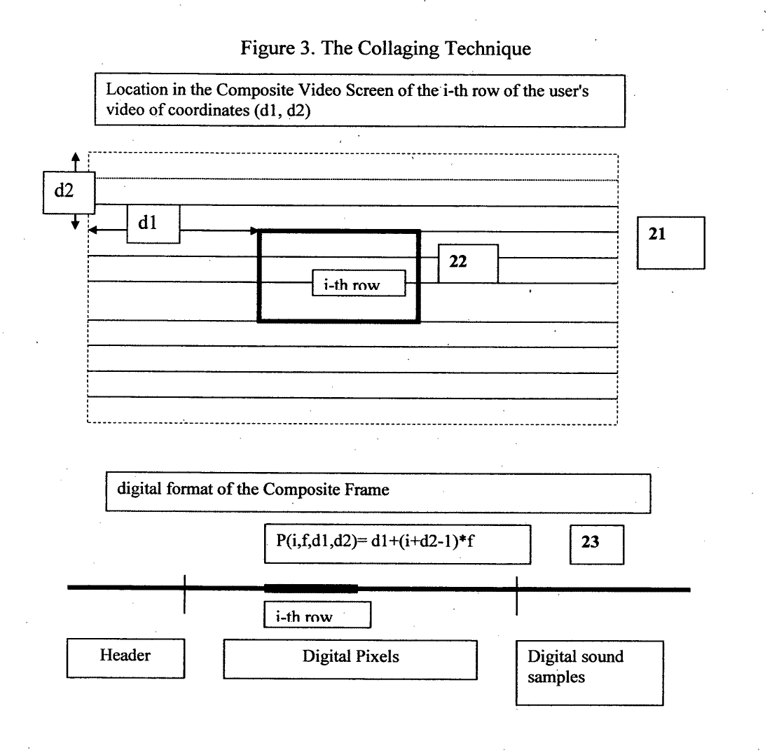

They are the coordinate d1 and d2 in the pixel space of the Composite Frame of the first pixel of the first row of the User' Frame in its location in the Composite Frame (6.1,16) (see FIG. 3). We assume that d1 is the distance from the left border of the Composite Frame and d2 is the distance from the upper border of the Composite Frame.

In the case of the Default Neighborhood (6.1.15, a)) we can establish the relationship between d1, d2 and:
L, the number of pixels in a row of the Composite Frame,
H, the number of pixel rows in the Composite Frame,
X, the number of pixels in a User's Frame row,
Y, the number of rows in the User's Frame,
The Coordinates c1 and c2 in the Virtual Screen of the receiver of the

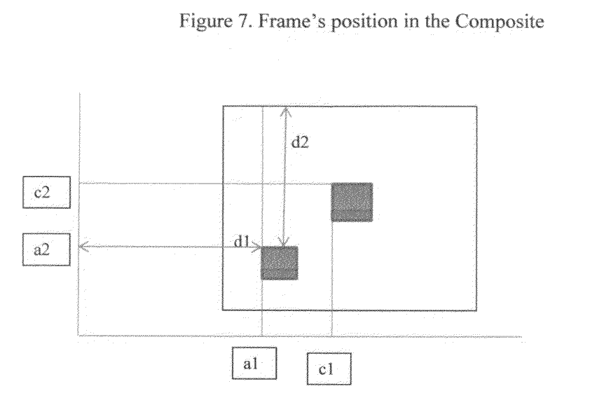

Composite Frame (FIG. 7)
The Coordinates a1 and a2 in the Virtual Screen of the User whose coordinate relative to the Composite frame are d1 and d2 (FIG. 7)

[symbol]

The Coordinates of the upper left point P of the Composite are:

p1=c1−X*(n−1)/2 p2=c2+Y*(m−1)/2 (see (6.1.12))

Where n=integer(L/X) and m=integer(N/n)=integer(N/integer(L/X)) (see 6.1.12.3)

Now we can write:

d1=a1−p1 d2=p2−a2

When a User logins VRTCOS assigns to the User the coordinates a1 and a2 and if user belongs to a number of already defined Neighborhoods, VRTCOS can calculate the User's d1 and d2 for each one of these Neighborhoods.

In the case of User Defined Neighborhood (6.1.12 b)) the values of d1 and d2 can be assigned once the Neighborhood Composite Video Geometry (6.1.14) is defined by the User.

### Neighborhood Composite Frame

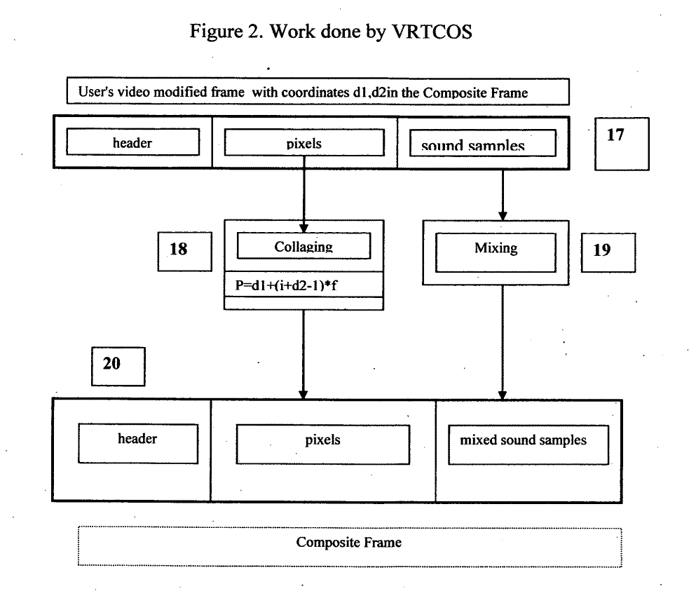

It is the current frame of the Neighborhood Composite Video, FIG. 2, 20. The size of this Frame, i.e. the number of horizontal pixels and the number of vertical pixels, is computed by VRTCOS using the User's Input Channel throughput and the Central Computer System characteristics. The size has to be such that the Central Computer System can create the Neighborhood Composite Frames and deliver them to destination at a standard video rate ( 1/30 or 1/15 of a second)

### User's Video Modified Frames

Are the frames, FIG. 1, 15, of the original webcam videos, modified in size (7.1.12) by VRTCOS (6.1.23).

### Central Time Interval (CTI)

It is an interval of the Central Computer System time at the beginning of which VRTCOS (6.1.23) activates the image capturing of the webcams of the users who have just logged in. By activating the webcams at regular time intervals of the Central Computer Time, VRTCOS (6.1.23) attempts to achieve a consistent Synchronization of the Video Frames capture (6.1.12.2)

At the same time the Internet Database Videos (6.1.5) which are in the Neighborhood of the Users whose webcam waits to be activated, are also downloaded.

The CTI is also the interval of time by which two consecutive Composite Frames (6.1.16) must arrive at a destination Computer. When the re-synchronization option (6.1.12.2) is activated the Composite Frames arrive at the destination Computer every 2*CTI seconds.

Usually CTI is 1/30 or 1/15 of a second.

The CTI is a System parameter and can be used for tuning the System performance.

### Maximum Wait Time (MWT)

It is the maximum time that VRTCOS (6.1.23) can wait for the arrival at the Central Computer of the frames that belong to the same Composite Frame (6.1.23). At MWT after the beginning of a CTI (6.1.18) VRTCOS (6.1.23) streams the Composite Frame to the destination Computer. MWT is a system parameter. If the frame re-synchronization option (6.1.12.2) is not activated, MWT is smaller or equal to CTI. If the re-synchronization is activated, MWT is smaller or equal to 2*CTI

### Capture Group

Capture Group is the set of all frames captured at the beginning of a CTI (6.1.18). The start of common capturing is triggered by VRTCOS (6.1.23) then each webcam will capture frames at CTI intervals.

By doing that, VRTCOS tries to increase the probability that frames of the same Capture Group arrive at the Server at the same time. Nevertheless different delay times between the capture of frames and their arrivals at the Central Computer System are inevitable. In order to minimize the impact of different arrival delays, VRTCOS uses a buffering of the Capture Groups (6.1.12.2).

We observe that if the objective of the Application Processor is to provide an environment for Users' interaction, the important requirement is that the temporal sequence of related actions by the users presented to the viewers is preserved, even if the frames are not simultaneous. For example, if a user asks a question to a second user, the first user will wait until the answer comes to him. The other users of the neighborhood will receive the question and the answer at different times but always in the order, first the question, then the answer.

### Frames' Collaging

The technique called Frames' Collaging allows to construct a Compressed Neighborhood Composite Frame, (6.1.16) from a set of Users' compressed Video Modified Frames, (6.1.17) and their coordinates d1,d2 in the Composite Frame. When Compressed frames, for example in JPEG format, from different User's videos arrive at the Central Computer System, the Component Frame Processor of VRTCOS gets the compressed frames from the Video streaming Software used by the System and it moves the frames' pixels lines into the pixel section of a pre-prepared Neighborhood Composite Frame (6.1.16), its i-th pixel line, FIG. 3, 22, being moved to the linear location of the Composite Frame's pixel section defined by the following formula

P(i,f,d1,d2)=d1+(i+d2−1)*f

where f is the number of pixels in a row of the Composite Frame, (6.1.16), FIG. 2, 18, and FIG. 3, 22.

Since the compression is done at the level of 8*8 block of pixels, the compression of the user's frame pixels is valid also for the Composite Frame.

### Sound Mixing

It is the process of mixing the digitalized sound samples of the current frames of a Neighborhood, and storing the result in the sound section of the Neighborhood Composite Frame (6.1.16), FIG. 2, 20. Initially the Composite Frame has zero values in the sound section. When a frame arrives its samples are mixed with the corresponding values in the Composite and the result is stored in the Composite sound section. One mixing technique is to perform the binary addition of the corresponding sound samples,

If the current frame belongs to a video whose User has not given permission to hear, the sound part of the frame is not used in the mixing

### Vrtcos Architecture

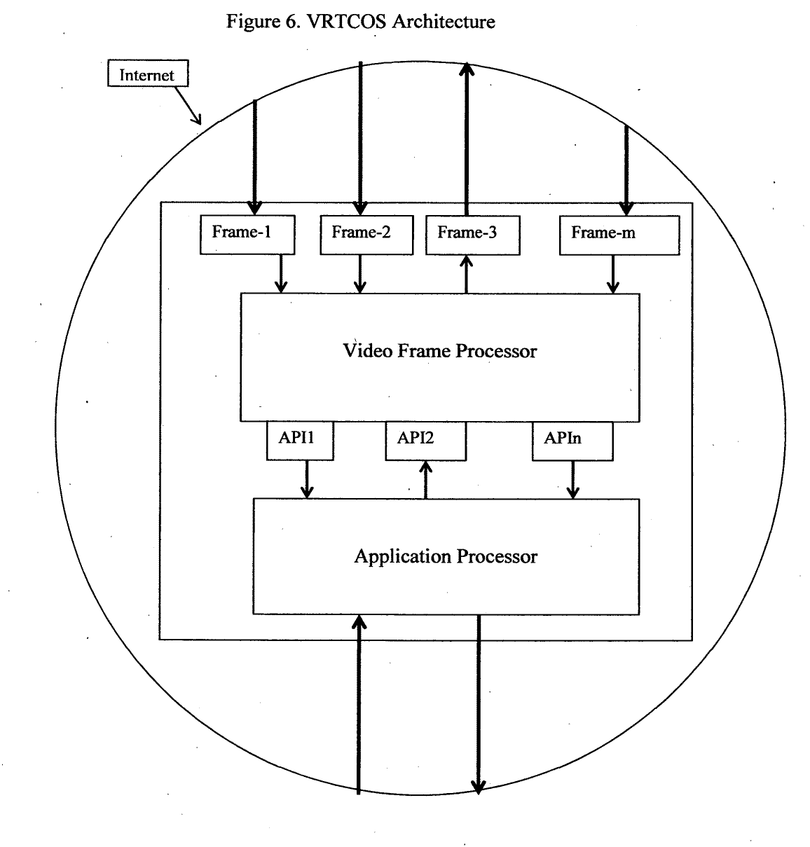

VRTCOS, or Video Real Time Communication System, is the Software System that provides the functionality described in this Patent. It resides in an Internet Server based on commercially available Hardware and Operating System. Its architecture is graphically represented in FIG. 6.

VRTCOS is made of two major Components, the Frame Processor and the Application Processor.

### Frame Processor

This Software Component receives Video Frames streamed from a multitude of sources connected to the Internet and it provides services to. an Application Processor (6.1.23.2), also residing in the Internet Server, for accessing the various information contained in a frame.

It also provides all necessary services to create new Frames requested by the Application Processor and to stream them to a destination computer whose ID is provided by the Application Processor.

The Frame Processor is a general Purpose Real Time Video Frame Manager which can interact, via Application Programming Interfaces (API-x), with a one or more Application Processors. The Application Processor (6.1.23.2) described in this patent is a particular Processor, designed for achieving the objectives of this Patent.

The Frame Processor's API-x are:

API-1. Create a Video Frame with given format and size with empty pixel section and sound section.

API-2. Detect the arrival at the Server of Video Frames streamed from Client Computers whose IDs are provided by the Application Processor.

API-3. As soon as a frame arrives, signal the Application Processor waiting for the Frame and pass to it the Computer ID of the frame

API-4. Copy the frame originated by a particular Computer ID to a location identified by the Application Processor

API-5. Copy a section of the frame, identified by the Application Processor, or part of it to a location identified by the Application Processor

API-6. Perform the mixing of the sound section of a Client's frame with the sound section of a Composite frame and store the result in the Sound section of the Composite Frame

API-7. Stream a Frame to a Destination Computer whose ID is provided by the Application Processor

### Application Processor

The Application Processor described in this Patent is a particular Software Component of VRTCOS (6.1.23) with the functionality required to achieve the objectives of this Patent

The Application Processor provides a website interface which allows the users to sign on by providing their User's Id and password. It verifies also the member acceptance. Various acceptance criteria can be implemented depending by the nature of the membership

After the user's sign on, the Application Processor download, in the User's computer, special software, called Client Software, that performs the following functions.

Client Software Specification
send the Computer's Internet ID of the Client's computer to the Application Processor
receive from VRTCOS (6.1.23) the number of pixels in a row, X, and the number of rows, Y, of the common webcam frame
upon receiving a command from the Application Processor, start the activation of the webcam
capture a webcam frame of size X*Y in Mpeg 2 format every CTI (6.1.18)
as soon as a frame is created, stream the frame with the local Computer ID to the Frame Processor
receive the Composite frames from the Frame Processor
display the Composite Frames on the local Screen
Perform User log out (send a signal to the Frame Processor)

To every Sender's Computer ID the Application Processor assign the Video Coordinates d1 and d2 (6.1.15.1) of the corresponding video in the Composite Video (6.1.13) FIG. 3

If the user's video is located in the p-th position of the q-th row, then

d1=(p−1)*X d2=(q−1)*Y

where X and Y are the dimension of the User's frame in pixels.

For every User's Computer ID the Application Processor computes the pixel position Pᵢ in the Composite Frame (6.1.16) where the i-th row of the user's video frames will be moved. The formula for Pᵢ is

Pᵢ(i,f,d1,d2)=d1+(i+d2−1)*f

where f is the number of pixels in a row of the Composite Frame.

The Application Processor can store the Pᵢ values in a table for each user's computer ID or it can compute these values when they are needed.

The Application Processor performs User's login procedure.

At login time it verifies the user ID, the User's password, the Internet ID of the User's Computer and set the Computer ID in the “waiting for webcam activation” state.

At intervals of CTI (6.1.18) VRTCOS (6.1.23) sends a “start capturing” signal to all the local computers in the “waiting for webcam activation” state

The Application Processor is waiting to be signaled by the Frame Processor for the arrival of the frames.

When the Application Processor is signaled by the Frame Processor (6.1.23.1) that a frame with its Computer ID arrived at the Central Computer, using the frame's Computer ID, the Application Processor retrieves or computes the Pᵢ (for i=1 to n) and asks the Frame Processor (API-5) to move the i-th row of the incoming frame to the position Pᵢ of the pixel section in the Composite Frame (6.1.16)

The Application Processor asks the Frame Processor (6.1.23.1) (API-6) to perform the sound mixing of the corresponding sound samples of the User's frame and the Composite Frame (6.1.16) and store the result in the sound section of the Composite Frame.

When all the N frames are processed, the Application Processor asks the Frame Processor to stream the Composite Frame (6.1.16) to the Receiver Computer (API-4), then it waits for the next signal from the Frame Processor.

If some of the N frames have not arrived within the an interval of MWT (6.1.18.1), the Application Processor asks the Frame Processor (6.1.23.1) to stream the Composite Frame and discard the users' frames that have not arrived yet

If a user logs out, the Application Processor sends a signal to the user's computer to stop the webcam capture

### The Virtual Screen

It is a two dimensional virtual space made of pixels, whose size is defined by VRTCOS (6.1.23) in such a way to contain all the reduced size video of all client who subscribed to the VRTCOS service. Each pixel has two coordinate, c1, c2. VRTCOS partitions the Virtual Screen in areas the size of a reduced size User's video, each area being defined by the coordinate c1, c2 (6.1.15), FIG. 4, of the pixel of the most upper left area's pixel

### DESCRIPTION OF THE DRAWINGS

The Description references the terms defined in 6.1. However the invention is not limited to the specific terms but includes all the technically equivalent elements.

Reference to a term will be identified by the paragraph number where the term has been defined.

The Drawings and their description explain the standard features of the Central Computer System running VRTCOS. Specific Application Processors can add more features.

FIG. 1 graphically represents the architecture of a Computer System whose components are a number of User's Devices, 1-10, a number of Internet Databases, 11-13, a Central Computer System, 14 and the Proprietary Software VRTCOS (6.1.23), all of them connected via Internet. All the hardware components are commercially available parts and are controlled by commercially available Operating Systems and by the proprietary software VRTCOS described in this patent. No special hardware is required. VRTCOS is made of two major components, the Frame Processor (6.1.23.1) and the Application Processor (7.1.23.2). The two Processors communicate between them via a set of APIs and to the Users' devices (see FIG. 6)

The Computer System allows the Users to communicate via videos by sending videos, captured by webcams connected to the User's Device, via Internet to the the Frame Processor and by receiving back in their device, upon request, a set of User's Videos, The Composite Video (6.1.13), in only one video stream. The total number of User's Videos (6.1.12.1) depends by the characteristics of the User's Devices and by the characteristics of the Central Computer System.

The Users sign in System, by connecting to an Application Processor (6.1.23.2) via Internet. During the sign-on procedure the User is requested to provide data about his profile (6.1.8), including User ID and password. All the signed-on Users form the User's Video Community.

When a User is signed-in, the VRTCOS downloads, to the User's Device, software to be executed in the User's Device. This Software, the Client Software (6.1.23.2, 3.2) allows the User's device to communicate with the Application Processor (6.1.23.2) and the Frame Processor (6.1.23.1).

At log-in time, the User is asked by the Central Computer System to identify a method for selecting the User's Neighborhood (6.1.12), i.e. the users whose videos the User wants to receive.

The user can chose between the Default User's Neighborhood (6.1.12,a) and User Defined Neighborhood (6.1.12,b). Once the Neighborhood type is selected, the number N of Users in the Neighborhood and the size S of the Neighborhood frames is determined (6.1.12). The User can communicate with the Neighborhood in accordance with the Privacy Status (6.1.8) of the users in the Neighborhood. At log-in time VRTCOS assign to the User two coordinates, c1 and c2 (6.1.15), which define the position of the User's video in the Virtual Screen (6.1.24). For each already defined Neighborhood, VRTCOS creates a Neighborhood Composite Frame, FIG. 1, 16, (6.1.16) and present to the User a proposed size S of the Neighborhood videos. The user can decide if he wants a different size. When a User log-in, VRTCOS identify all the Neighborhoods to which the User's video belongs (6.1.12,a,(1)) and calculates the coordinates d1 and d2 (6.1.15,1) of the User's video inside the Composite Frame of all these Neighborhoods.

At log-in time VRTCOS also assigns each User's Composite to a Computer processor in the multi-processors central system

The processing at log-in time is done at the same time when VRTCOS is processing the Video Frames of all the users that have finished the log-in procedure. This requirement implies that the Central Computer System must be a multi-processors System, where some of processors are dedicated to the Log-in procedure and other to processing the Video Frames.

After the User's Neighborhood is defined and the size of the Neighborhood videos is accepted by the User, the User's webcam is waiting to be activated by VRTCOS. During a Central Time Interval (6.1.18), or CTI, the following processing is performed by VRTCOS.
1) At the beginning of each CTI, VRTCOS send a signal to the Client Software (6.1.23.2,3.2) to start capturing webcam frames of all the User's waiting to be activated and a signal to the Databases where the Videos included in those Users' Neighborhood resides to upload the videos to the Central Computer System. The webcam Frames are captured with the agreed upon size and the Database Frames are converted to the agreed upon size. At the beginning of every CTI the Local software capture a new webcam frame.
2) The frames of all these videos are streamed to VRTCOS by the Client Software.
3) When a Video Frame from a User's Video or from an Internet Database Video arrives at the Central Computer System, VRTCOS sends a copy of the frame and the identification of the frame source to all the computer processors allocated to Neighborhoods that contain the frame.
4) In each one of these processors the frame is received by the Frame Processor (6.1.23.1) of VRTCOS. The Frame Processor signal the Application Processor (6.1.23.2) of the frame arrival and the Application Processor, using the Frame processor's APIs, asks the Frame Processor to transfer the frame's digital pixels to the appropriate location in the Composite Frame by performing the Collaging Technique (6.1.21) (see also FIG. 2 and FIG. 3 Description) and to mix the frame's sound samples (6.1.22) with the ones in the Composite Frame.
5) At the end of the CTI, the Composite Frame is streamed to the Destination Computer. The data in the Composite will not be deleted. There is a possibility that at that time not all the frames of the Neighborhood's users have been processed. VRTCOS offers two options. The first option is to stream the Composite and to use the previous frame values for all the frames that are not arrived. The second option (6.1.12.2) is to wait another CTI before streaming the Composite. The second option implies that the Frame frequency of the streamed Composite is twice the CTI. In some application of the Technology it may be possible to consider using Network very fast transmission technologies, such as Frame Relay, which certainly improve the probability of keeping the frames' simultaneity

A User can dynamically request to change the Neighborhood in two different way depending by the Type of Neighborhood selected. If the User selects the Default Neighborhood (6.1.12, a)), the User can ask to change location in the Virtual Screen and the User will be assigned the closest available location to the one requested. If the User selects the User Defined Neighborhood, (6.1.12 b)), the User can change the Neighborhood by providing different criteria based on users' profiles.

In both cases there will be a temporary interruption of the User's Composite delivery to allow VRTCOS to prepare the new setting of the User's Composite and the new list of Neighborhoods where the User's Video belong to.

When the User receives the Neighborhood videos , the User can select a subset of them and request permission to these users to video-interact with them. This requires that the selected users allow the requesting user to hear them. Upon acceptance, the User can start a video/audio communication with the selected users.

This processing is repeated every CTI for every video frame that reaches VRTCOS. The total number of Users (6.1.21.1, N&C Table) that can be supported depends by the computing power of the Central Computer System. Our estimate is that an AMD 6000 can handle about 760 Composites each one with 15 Users, which is equivalent to 760*15=11,400 Users.

One Large Cray XTS System can accommodate up to 240,000 AMD 6000 processors. It can handle about 2.736 billion of users.

FIG. 2 is a graphic representation of the process performed by the VRTCOS on a generic Users' Video Frame, FIG. 2, 17, (6.1.17) and of the generation of the Neighborhood Composite Frame, FIG. 2, 20, (6.1.16) by using the Frames' Collaging technique (6:1.21) and the Sound Mixing (6.1.22).

During each CTI (6.1.18), the VRTCOS create the content of each Composite Frame by performing the Collaging, FIG. 2, 18, and the Mixing, FIG. 2, 19, techniques. This process is terminated after a time equal to the Maximum Waiting Time or MWT(6.1.18.1). The CTI and the MWT are System parameters defined in such a way that the rate of arrival of the Neighborhood Composite Frames to destination is a standard video rate ( 1/30 or 1/15 of a second)

FIG. 3 is a graphic representation of the Frames' Collaging Technique (6.1.21)

The figure shows the position of a User's Frame FIG. 3, 22, in the Neighborhood Composite Frame, FIG. 3, 21, and the location P of the i-th row of the User's Frame in the neighborhood Composite Frame, FIG. 3, 23.

FIG. 4 shows the two types of Neighborhood, the Default User's Neighborhood ((6.1.12, a)), with the Virtual Screen, FIG. 4, 15, and a Composite Video, FIG. 4, 16, and a User Defined Neighborhood ((6.1.12, b)), with two examples of Neighborhood Composite Video Geometry, (6.1.14), rectangular, FIG. 4, 17 and circular FIG. 4, 18

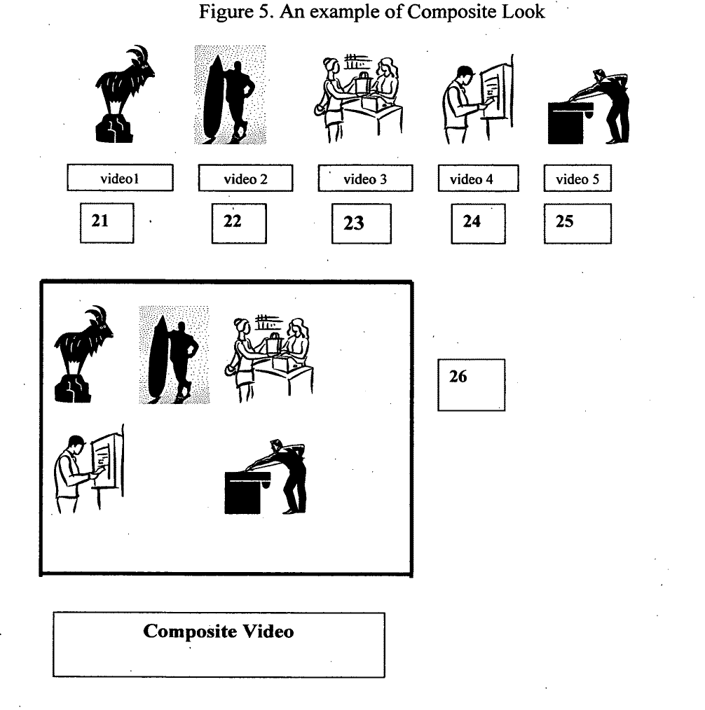

FIG. 5 shows the frames of five User's Videos, 21 to 25, as captured by five User's webcam and the corresponding Composite Video Frame, 26, as it may appears in the requesting User's screen.

FIG. 6 shows the architecture of VRTCOS, with its two major components , the Frame Processor (7.1.23.1) and the Application Processor (6.1.23.2)

Each one of these Processors communicates with each other via APIs and with the User's devices via Internet and the Client Software.

FIG. 7 shows the coordinates of the User's frame and the coordinates of a generic Neighbor's frame inside the Composite frame

We describe four claims for this invention

1. The method of delivering (via Internet) a number of real time videos, captured by webcams or delivered from databases, to one User device in one video stream, using commercially available Computers and a proprietary software named VRTCOS (6.1.23) running on a Central Computer System
The method includes:
a) the definition of Neighborhood (6.1.12) started by each User at sign-in time with the two options of Default Neighborhood and User defined Neighborhood.
b) the definition of Virtual Screen (6.1.24) and the assignment of a Location in the Virtual Screen to any User, by assigning two coordinates c1,c2 in a system of reference of the Virtual Screen Space
c) the delivery to each User's device of the software (6.1.23.2,3.2) for capturing the webcam videos in a common format
d) the action to start the video capturing from the Central Computer System to the User's Device at Central Time Intervals (6.1.18) defined by VRTCOS
e) the technique of intercepting (6.1.23.1, API-2) the streamed User's frames at the Central Computer System and making available the frame content to an Application Processor
f) the creation of a User's Composite (6.1.16) Video Frame containing all the video frames of the User's Neighborhood, using the proprietary technique of Collaging (7.1.21) for the pixel part of the frame and the Mixing (6.1.22) technique for the sound part of the frame
g) the technique for improving the re-synchronization (6.1.12.2) of the users' frames that belong to the same Neighborhood
h) the technique to dynamically change the User's Neighborhood (6.1.12, a1)) by changing users' selection criteria or by asking to change location in the Virtual Screen

2. The technique of Collaging (6.1.21) to create a Composite Video Frame from a set of video frames.
The technique includes:
a) computing the Composite Video Frame (6.1.16) size in such a way that a Computer System can create the Neighborhood Composite Frames and deliver them to destination at a standard Video rate ( 1/30 or 1/15 of a second)
b) resizing all the video frames (6.1.17) in a Neighborhood to fit into the Composite Video Frame
c) assigning two coordinate (6.1.15.1) d1 and d2, relative to a Composite Frame to each video frame, and positioning the first pixel of the first row of the User's Video in the d1-th pixel position of the d2-th row of the Composite Video.
d) move the ith-row of the video frame of coordinates d1 and d2 into the linear position P(i,f,d1,d2)=d1+(i+d2−1)*f of the pixel part of the Composite Video Frame (see FIG. 3) and repeat the move for each row of the video frame of coordinates d1 and d2.
f is the number of pixels in a row of the Composite Video Frame.

3. The Virtual Screen (6.1.24) model.
The model includes:
a) a two-dimensional space, named Virtual Screen, in which each dimension is measured in digital pixels.
b) the partitioning of the Virtual Screen in User's Frames, one for each user, identified by two integers , c1 and c2, the coordinate of the first pixel of the first row of the User's frame
c) The identification in the Virtual Screen of a user Neighborhood for each user, defined in term of c1, c2, the size of the Composite Frame and the size of User's frames in the Neighborhood

4. The Frame Processor.
This processor is a General Purpose Frame Processing Utility which can be used in connection with a large set of Application Processors.
The services offered by this utility are:
a) Intercept a streamed video frame at its arrival at destination
b) Signal the video frame arrival to an Application Processor
c) Make available to an Application Processor the content of the intercepted frame
d) Transfer sections of a video frame content to another video frame
e) Create a new video frame
f) Stream a video frame to a Destination Computer
